(19) United States
(12) Patent Application Publication
(10) Pub. No.: US 2020/0065143 A1
(43) Pub. Date: Feb. 27, 2020

(54) SAFETY SHUTDOWN CONTROL OF VIRTUAL MACHINES RUNNING ON A HOST APPARATUS

(71) Applicant: FUJITSU LIMITED, Kawasaki-shi (JP)

(72) Inventor: Keisuke Imamura, Setagaya (JP)

(73) Assignee: FUJITSU LIMITED, Kawasaki-shi (JP)

(21) Appl. No.: 16/524,245

(22) Filed: Jul. 29, 2019

(30) Foreign Application Priority Data
Aug. 27, 2018 (JP) 2018-158325

(51) Int. Cl. G06F 9/48; G06F 9/455; G06F 12/0804

(52) U.S. Cl. CPC G06F 9/4893; G06F 2212/1032; G06F 12/0804; G06F 9/45533

(57) ABSTRACT

An apparatus sets a priority for each of a plurality of virtual machines such that a higher priority is given for a virtual machine having a lower processing load, and sets a precedence order of Input/Output (I/O) processing based on the priority in a case where a power supply of the information processing apparatus is switched to an uninterruptible power supply, where the priority is based on processing loads of the plurality of virtual machines immediately before the power supply of the information processing apparatus is switched to the uninterruptible power supply, and the I/O processing indicates at least one of writing from each of the plurality of virtual machines to the memory and reading from the memory to the virtual machine. The apparatus performs, for each of the plurality of virtual machines, the I/O processing from the virtual machine to the memory in accordance with the precedence order.

### CROSS-REFERENCE TO RELATED APPLICATION

This application is based upon and claims the benefit of priority of the prior Japanese Patent Application No. 2018-158325, filed on Aug. 27, 2018, the entire contents of which are incorporated herein by reference.

### FIELD

The embodiments discussed herein are related to safety shutdown control of virtual machines running on a host apparatus.

### BACKGROUND

In recent years, improved performance of an information processing apparatus has enabled many virtual machines to operate on a single host apparatus. In the case where disk images of the virtual machines are present in a storage unit (for example, a hard disk) of the host apparatus, the virtual machines perform input/output (I/O) processing on the storage unit. When the host apparatus shuts down because of a power failure or the like, the virtual machines also shut down. If a virtual machine shuts down in a state in which I/O processing of information used for the operation is unfinished, the disk image is damaged, making it difficult for the virtual machine to start up next time. Therefore, a technique is used which enables virtual machines and a host apparatus to safely shut down by introducing an uninterruptible power supply (UPS) and by completing I/O processing for the virtual machines before the host apparatus shuts down.

As a related art, there has been proposed a system including a plurality of virtualization servers and a fail-safe device. Each of the plurality of virtualization servers is connected to a UPS and runs a plurality of virtual machines. The fail-safe device has a fail-safe function against a power failure (see, for example, Japanese Laid-open Patent Publication No. 2009-282714).

As a related art, there has been proposed a technique of calculating a time to start terminating the operation of each virtual machine within a power supply available time period of a UPS and of performing a process of terminating the operation of the virtual machine in accordance with the time (see, for example, International Publication Pamphlet No. WO 2013/136502).

As a related art, there has been proposed a technique for reducing downtime in a virtual environment in response to a failure, by restarting virtual machines using a copy of data in response to the failure (see, for example, Japanese Laid-open Patent Publication No. 2015-69655).

As a related art, there has been proposed a virtual machine that enables an I/O operation of a guest operating system (OS) to be performed by configuring a device such that the device is directly operable from the guest OS and by emulation (see, for example, Japanese Laid-open Patent Publication No. 2008-305034).

### SUMMARY

According to an aspect of the embodiments, an apparatus sets a priority for each of a plurality of virtual machines such that a higher priority is given for a virtual machine having a lower processing load, and sets a precedence order of Input/Output (I/O) processing based on the priority in a case where a power supply of the information processing apparatus is switched to an uninterruptible power supply, where the priority is based on processing loads of the plurality of virtual machines immediately before the power supply of the information processing apparatus is switched to the uninterruptible power supply, and the I/O processing indicates at least one of writing from each of the plurality of virtual machines to the memory and reading from the memory to the virtual machine. The apparatus performs, for each of the plurality of virtual machines, the I/O processing from the virtual machine to the memory in accordance with the precedence order.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a schedule of shutdown processes of virtual machines and a host apparatus;

FIG. 2 illustrates an example of I/O processing performed when a power failure occurs in a virtual environment;

FIG. 3 is a diagram illustrating an example of a procedure of I/O processing performed when a power failure occurs;

FIG. 4 is a diagram illustrating an example of a system configuration according to a first embodiment;

FIG. 5 is a diagram illustrating a first example of a priority setting method;

FIG. 6 is a diagram illustrating a first example of a priority list;

FIG. 7 is a diagram illustrating an example of a procedure of I/O processing performed based on a priority when a power failure occurs;

FIG. 8 is a diagram illustrating an example in which I/O processing is performed based on the priority when a power failure occurs in a virtual environment;

FIG. 9 is a flowchart illustrating an example of a process performed by a priority setting unit according to the first embodiment;

FIG. 10 is a flowchart illustrating an example of a process performed by a shutdown processing unit;

FIG. 11 is a flowchart illustrating an example of a process performed by a precedence order setting unit;

FIG. 12 is a flowchart illustrating an example of a process performed by an I/O execution unit;

FIG. 13 is a diagram illustrating a second example of the priority setting method;

FIG. 14 is a diagram illustrating a second example of the priority list;

FIG. 15 is a flowchart illustrating an example of a process performed by the priority setting unit according to a second embodiment; and

FIG. 16 is a diagram illustrating an example of a hardware configuration of a host apparatus.

### DESCRIPTION OF EMBODIMENTS

Even if the power supply of an information processing apparatus (host apparatus) is switched to a UPS upon occurrence of a power failure, the battery may go dead and consequently the host apparatus may shut down before I/O processing is completed for all virtual machines. In such a case, disk images of the virtual machines are damaged, making it difficult for the virtual machines to start up next time.

In the case where the host apparatus includes a single storage unit, there is a period for which a virtual machine waits for completion of I/O processing requested by another virtual machine. For example, if processing of a virtual machine having a large amount of I/O processing is started first, I/O processing is not completed for the other virtual machines. Consequently, the number of virtual machines to be forcibly shut down increases. The amount of I/O processing varies depending on timing. Thus, it is difficult to estimate the amount of I/O processing when each virtual machine is set up.

If a UPS having a large power supply capacity is prepared, a period ensured before the host apparatus shuts down increases. However, such a UPS is costly.

It is preferable to increase the number of virtual machines for which I/O processing is successfully completed within the operable period of the UPS and which is successfully shut down safely.

### First Embodiment

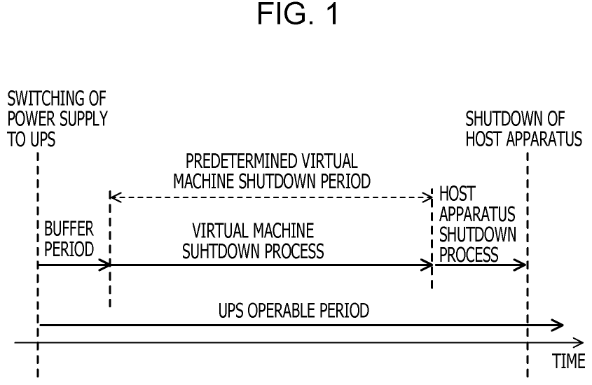

A first embodiment will be described below with reference to the accompanying drawings. FIG. 1 is a diagram illustrating an example of a schedule of shutdown processes of virtual machines and a host apparatus. The shutdown process of the host apparatus indicates a process of terminating processes of a portion of the host apparatus (such as the OS of the host apparatus) other than the virtual machines and then shutting down the entire host apparatus.

As illustrated in FIG. 1, in the case where the power supply of the host apparatus is switched from the system power supply to a UPS upon occurrence of a power failure, virtual machines start shutdown processes after a certain buffer period elapses. A predetermined period assigned as a virtual machine shutdown period is set in advance. If incomplete I/O processing exists, each virtual machine performs the incomplete I/O processing in this predetermined period to perform the shutdown process. Upon an elapse of the predetermined period, the virtual machine is forcibly shut down even if the I/O processing is not completed. It is assumed that I/O processing indicates at least one of reading from a storage unit of the host apparatus to a virtual machine and writing to the storage unit of the host apparatus from the virtual apparatus.

After all the virtual machines are shut down or after the predetermined virtual machine shutdown period elapses, the host apparatus starts the shutdown process. As described above, by setting the predetermined virtual machine shutdown period in advance, a schedule is set such that the host apparatus shuts down within an operable period of the UPS regardless of whether I/O processing is completed for the virtual machines.

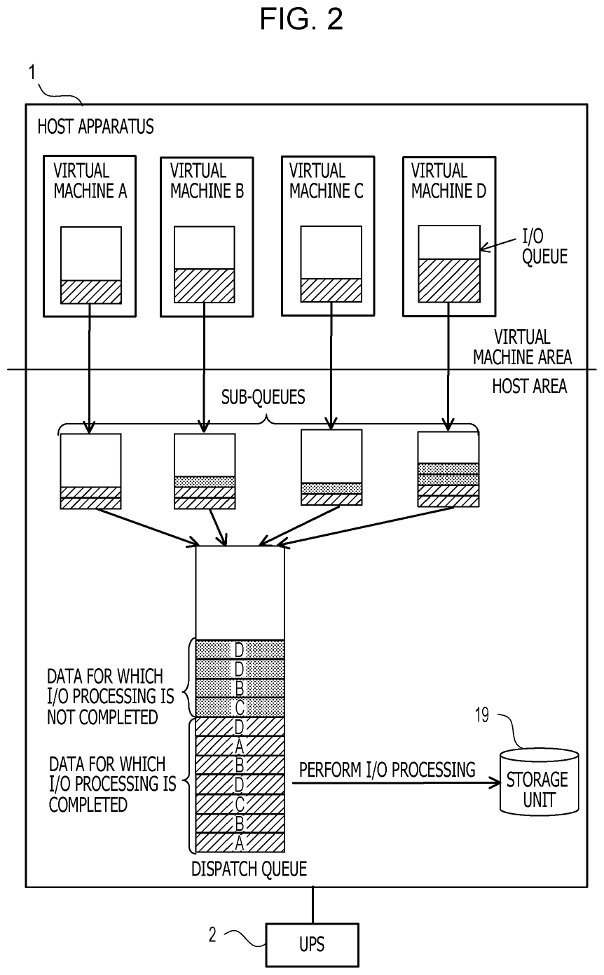

FIG. 2 illustrates an example of I/O processing performed when a power failure occurs in a virtual environment. A system illustrated in FIG. 2 includes a host apparatus 1 and a UPS 2. When a power failure occurs while the host apparatus 1 is operating, the power supply of the host apparatus 1 is switched from the system power supply to the UPS 2.

It is assumed that a plurality of virtual machines (virtual machines A to D) are operating on the host apparatus 1. In a storage area of the host apparatus 1, an area relating to the virtual machines is referred to as a virtual machine area, whereas the rest of the area is referred to as a host area. It is also assumed that I/O queues, sub-queues, and a dispatch queue are queues implemented in a memory and that a storage unit 19 is an auxiliary storage device (for example, a hard disk drive). Each of the I/O queues illustrated in FIG. 2 depicts data for which I/O processing is incomplete in the corresponding virtual machine at the time of occurrence of the power failure.

The host apparatus 1 acquires pieces of data held in the I/O queues of the virtual machines as sub-queues in a kernel space of the host area, for example. The host apparatus 1 then moves the pieces of data from the sub-queues to the dispatch queue. The dispatch queue is a queue to which the pieces of data held in the sub-queues are collected. The pieces of data enqueued in the dispatch queue are subjected to I/O processing to the storage unit 19 in an order in which the pieces of the data are enqueued. That is, first in, first out (FIFO) processing is applied to the sub-queues and the dispatch queue.

In the example illustrated in FIG. 2, for example, the host apparatus 1 enqueues the pieces of data in the dispatch queue in an order in which corresponding I/O processing requests are generated and performs I/O processing from the dispatch queue to the storage unit 19. However, as illustrated in FIG. 1, the host apparatus 1 is shut down upon an elapse of the predetermined virtual machine shutdown period even if the I/O processing is not completed. Thus, I/O processing of part of data to the storage unit 19 may be incomplete.

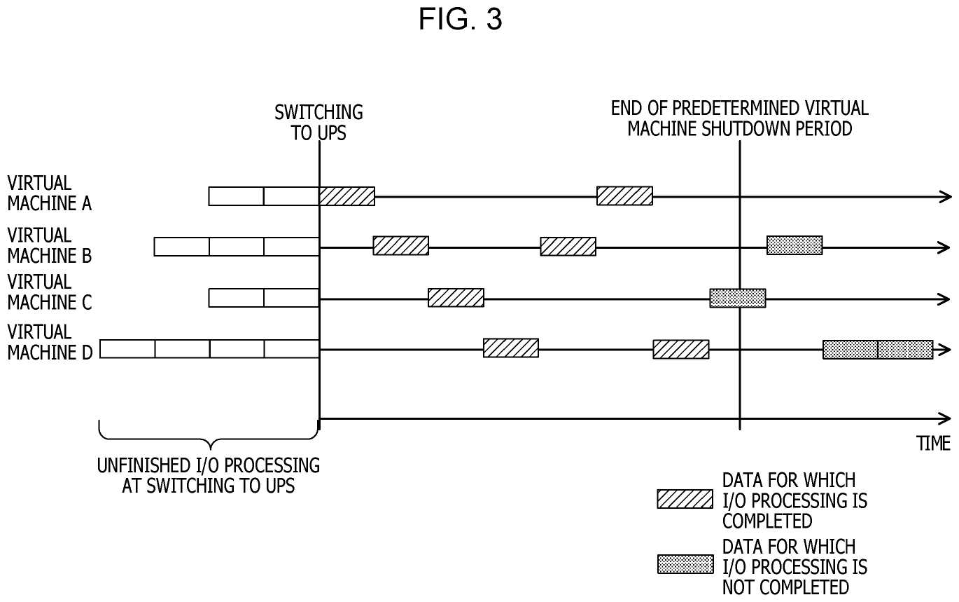

FIG. 3 is a diagram illustrating an example of a procedure of I/O processing performed when a power failure occurs. As illustrated in FIG. 3, after the power supply of the host apparatus 1 is switched to the UPS 2 upon occurrence of a power failure, I/O processing of data is performed for each virtual machine. As described above, the predetermined virtual machine shutdown period is set in advance. Thus, the virtual machines are forcibly shut down upon an elapse of the predetermined virtual machine shutdown period even if the I/O processing is not completed for all the virtual machines.

In the example illustrated in FIG. 3, the I/O processing is completed for the virtual machine A within the predetermined virtual machine shutdown period. Thus, the virtual machine A is shut down safely. In contrast, the I/O processing is not completed for the virtual machines B, C, and D within the predetermined virtual machine shutdown period. Thus, the virtual machines B, C, and D are forcibly shut down before the I/O processing is completed. In this case, disk images of the virtual machines B, C, and D held in the storage unit 19 may be in an abnormal state. If the disk images are in the abnormal state, the virtual machines B, C, and D may fail to start up next time or may have difficulty in continuing a service because of a data loss.

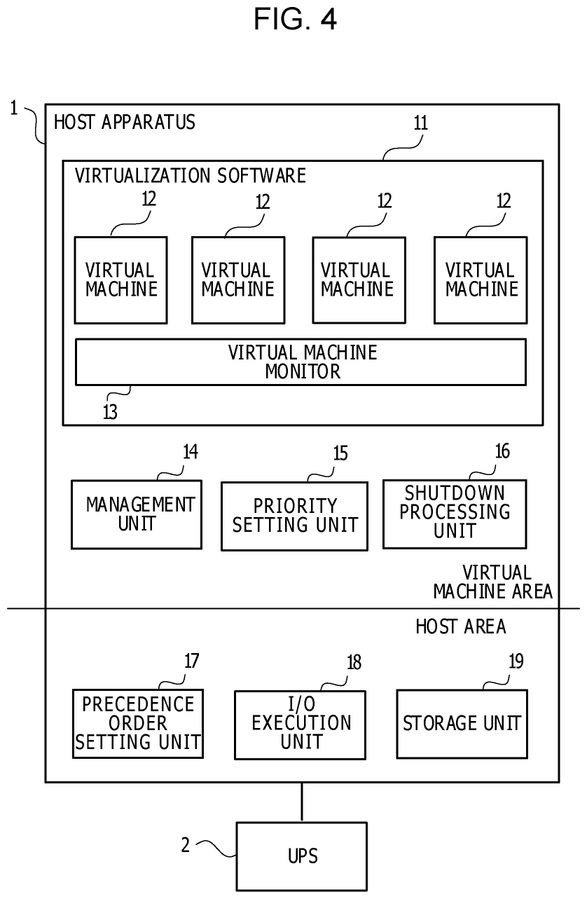

FIG. 4 is a diagram illustrating an example of a system configuration according to the first embodiment. The system according to the first embodiment includes the host apparatus 1 and the UPS 2. The host apparatus 1 is connected to the UPS 2.

The host apparatus 1 includes virtualization software 11, a management unit 14, a priority setting unit 15, a shutdown processing unit 16, a precedence order setting unit 17, an I/O execution unit 18, and the storage unit 19. The virtualization software 11, the management unit 14, the priority setting unit 15, and the shutdown processing unit 16 are implemented in the virtual machine area that is a storage area of the host apparatus 1 relating to the virtual machines. The precedence order setting unit 17, the I/O execution unit 18, and the storage unit 19 are implemented in the host area that is a storage area other than the storage area relating to the virtual machines. The host apparatus 1 is, for example, a server. The host apparatus 1 is an example of an information processing apparatus and a computer.

Upon detecting a power failure of the system power supply, the UPS 2 supplies electric power to the host apparatus 1 from a battery included in the UPS 2. That is, upon detecting a power failure of the system power supply, the UPS 2 switches the power supply of the host apparatus 1 from the system power supply to the battery included in the UPS 2, for example. The UPS 2 also transmits, to the host apparatus 1, a certain notification indicating that the power supply is switched from the system power supply to the battery.

The virtualization software 11 has an emulation function for implementing virtual machines 12. The plurality of virtual machines 12 operate on the virtualization software 11. The virtualization software 11 also includes a virtual machine monitor 13 that monitors each of the virtual machines 12.

The management unit 14 is software that manages the virtual machines 12. The management unit 14 performs a startup process and a shutdown process for each of the virtual machines 12, for example. The management unit 14 also manages information concerning amounts of I/O processing or central processing unit (CPU) usages of the respective virtual machines 12.

The priority setting unit 15 acquires information concerning the processing loads of the plurality of virtual machines 12 from the management unit 14. Based on the acquired information, the priority setting unit 15 sets a priority for each of the plurality of virtual machines 12 such that a higher priority is given for a lower processing load. The priority setting unit 15 also generates a priority list. The processing loads are, for example, amounts of I/O processing of the respective virtual machines 12 in a certain immediately preceding period. For example, the priority setting unit 15 sets a higher priority for the virtual machine 12 having a smaller amount of I/O processing in the certain immediately preceding period. The priority setting unit 15 stores the priority (priority list in which the priority is recorded) in a memory.

In the case where the power supply of the host apparatus 1 is switched to the UPS 2, the shutdown processing unit 16 starts shutdown processes of the virtual machines 12 and acquires the latest priority list from the memory. The shutdown processing unit 16 then outputs, to the precedence order setting unit 17, the priority list and a start notification indicating that the shutdown processes of the virtual machines 12 are started. The shutdown processing unit 16 sequentially completes the shutdown processes of the virtual machines 12 from the shutdown process of the virtual machine 12 for which the I/O processing is completed first.

In the case where the power supply of the host apparatus 1 is switched to the UPS 2, the precedence order setting unit 17 receives the priority list including the latest priority set by the priority setting unit 15. Based on the priority list, the precedence order setting unit 17 sets a precedence order of I/O processing from the plurality of virtual machines 12 to the storage unit 19. The latest priority is a priority based on the processing loads of the plurality of virtual machines 12 in the certain period immediately before the power supply of the host apparatus 1 is switched to the UPS 2. The precedence order setting unit 17 sets the precedence order of I/O processing by sequentially moving the pieces of data from the sub-queues to the dispatch queue from the piece of data of the virtual machine 12 assigned the highest priority in the priority list.

The I/O execution unit 18 performs, for each of the plurality of virtual machines 12, I/O processing from the virtual machine 12 to the storage unit 19, based on the precedence order set by the precedence order setting unit 17. The I/O execution unit 18 sequentially performs I/O processing to the storage unit 19 from the piece of data that has been moved to the dispatch queue first, for example.

The precedence order setting unit 17 and the I/O execution unit 18 are an example of an input/output processing unit. That is, the input/output processing unit performs I/O processing between the plurality of virtual machines 12 and the storage unit 19 in accordance with the precedence order.

The storage unit 19 stores the pieces of data used by the virtual machines 12. The storage unit 19 stores, for each of the virtual machines 12, a disk image of the virtual machine 12, for example. It is assumed that the storage unit 19 is an auxiliary storage device (for example, a hard disk drive).

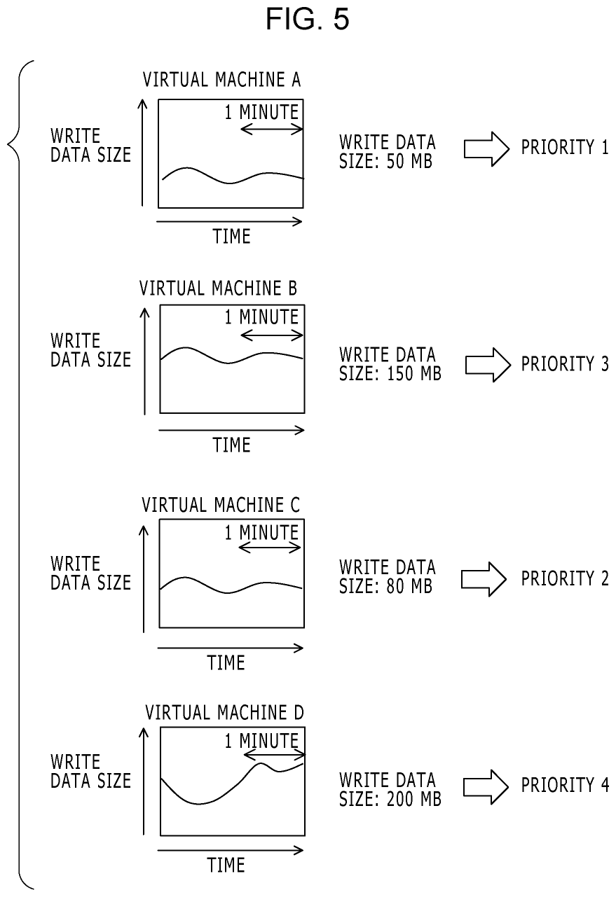

FIG. 5 is a diagram illustrating a first example of the priority setting method. As described above, the priority setting unit 15 acquires, from the management unit 14, the information concerning the processing loads of the plurality of virtual machines 12 in the certain immediately preceding period. The priority setting unit 15 then sets the priority for the plurality of virtual machines 12 based on the acquired information. In the example illustrated in FIG. 5, the priority setting unit 15 sets the priority based on the sizes of pieces of data written by the respective virtual machines 12 in a certain period (one minute) immediately before the power supply is switched to the UPS 2. The priority setting unit 15 uses the size of the write data in the example illustrated in FIG. 5. However, the priority setting unit 15 may use the size of the read data or the total size of the read data and the write data. In addition, the certain period used for the setting is not necessarily one minute.

In the example illustrated in FIG. 5, the write data sizes of the virtual machines A, B, C, and D in the certain period (one minute) immediately before the power supply is switched to the UPS 2 are 50 megabytes (MB), 150 MB, 80 MB, and 200 MB, respectively. The priority setting unit 15 sets a higher priority for the virtual machine 12 having a smaller write data size.

When the write data size in the period immediately before the power supply is switched to the UPS 2 is small, it is considered that the amount of I/O processing remaining at the time of the power failure is also small. Therefore, the priority setting unit 15 sets a higher priority for the virtual machine 12 having a smaller write data size. Consequently, the shutdown process of the virtual machine 12 is completed earlier, and the possibility that writing is not completed for the other virtual machines is successfully reduced. Accordingly, the host apparatus 1 may increase the number of virtual machines 12 for which I/O processing is successfully completed within the operable period of the UPS 2 and which is successfully shut down safely.

The host apparatus 1 sets an amount of I/O processing by using an amount of I/O processing that has been performed immediately before the power supply is switched to the UPS 2. Thus, the host apparatus 1 may appropriately set the priority even in a system in which an amount of I/O processing varies depending on timing.

In addition, the priority setting unit 15 that sets the priority and the management unit 14 that manages amounts of I/O processing of the virtual machines 12 are implemented by a program different from that of the virtual machines 12. Therefore, the host apparatus 1 is capable of setting the priority without changing the program of the virtual machines 12. For example, when virtual appliances are used as the virtual machines 12, a dedicated OS is often used. Thus, it is not easy to change the program. However, since the host apparatus 1 sets the priority without changing the program of the virtual machines 12, an amount of work for changing the program may be reduced or no longer required.

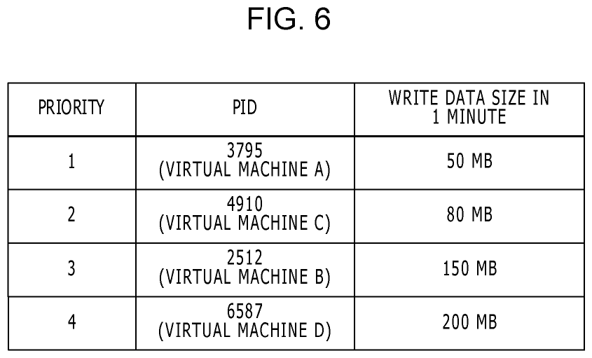

FIG. 6 is a diagram illustrating a first example of the priority list. The priority list illustrated in FIG. 6 is generated in the case where the priority is set in accordance with the method illustrated in FIG. 5. In the priority list illustrated in FIG. 6, the priority, a process identifier (PID) of the virtual machine, and the size of data written in a one-minute period immediately before the power supply is switched to the UPS 2 are stored in association with one another. In the example illustrated in FIG. 6, a higher priority is set in ascending order of write data size. Specifically, a higher priority is set in an order of the virtual machines A, C, B, and D, for example.

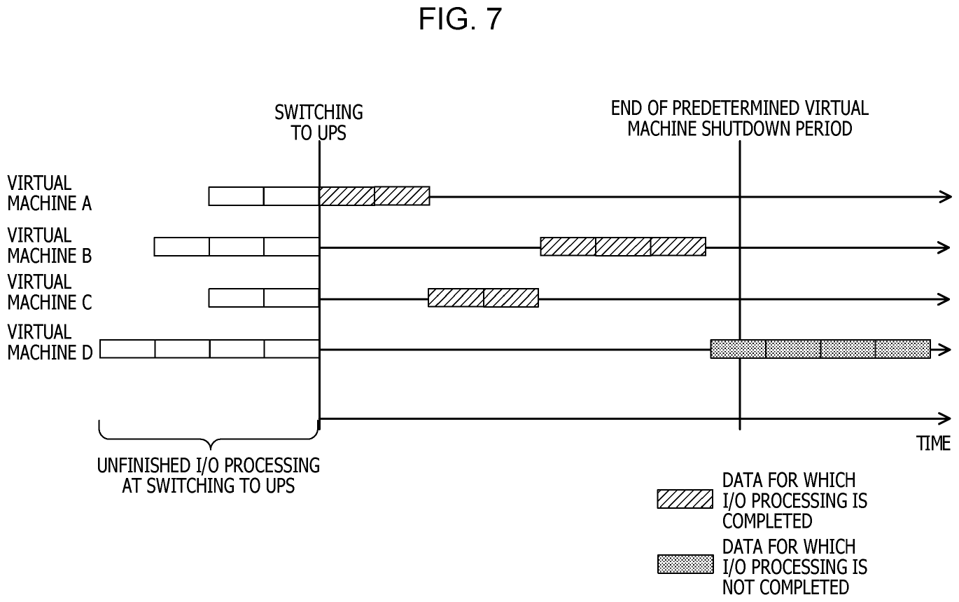

FIG. 7 is a diagram illustrating an example of a procedure of I/O processing performed based on the priority when a power failure occurs. In the example illustrated in FIG. 7, amounts of I/O processing remaining when the power supply of the host apparatus 1 is switched to the UPS 2 are the same as those in the example illustrated in FIG. 3. In the example illustrated in FIG. 7, the I/O execution unit 18 performs I/O processing for the virtual machines in accordance with the precedence order set based on the priority of the virtual machines illustrated in FIG. 6.

The host apparatus 1 performs I/O processing for the virtual machines in an order of the virtual machines A, C, B, and D in accordance with the priority of the virtual machines illustrated in FIG. 6. The I/O processing is completed for the virtual machines A, C, and B within the predetermined virtual machine shutdown period. Thus, the virtual machines A, C, and B are successfully shut down safely.

In the example illustrated in FIG. 3, the I/O processing is not completed for three virtual machines (the virtual machines B, C, and D) within the predetermined virtual machine shutdown period. In contrast, in the example illustrated in FIG. 7, the number of virtual machines for which the I/O processing is not completed within the predetermined virtual machine shutdown period is one (the virtual machine D). That is, when the power supply of the host apparatus 1 is switched to the UPS 2, the host apparatus 1 performs I/O processing for each virtual machine in accordance with the set priority. This may increase the number of virtual machines for which the I/O processing is completed and which is safely shut down. Therefore, the host apparatus 1 may improve safety in shutting down the plurality of virtual machines 12 and the host apparatus 1 at the time of a power failure.

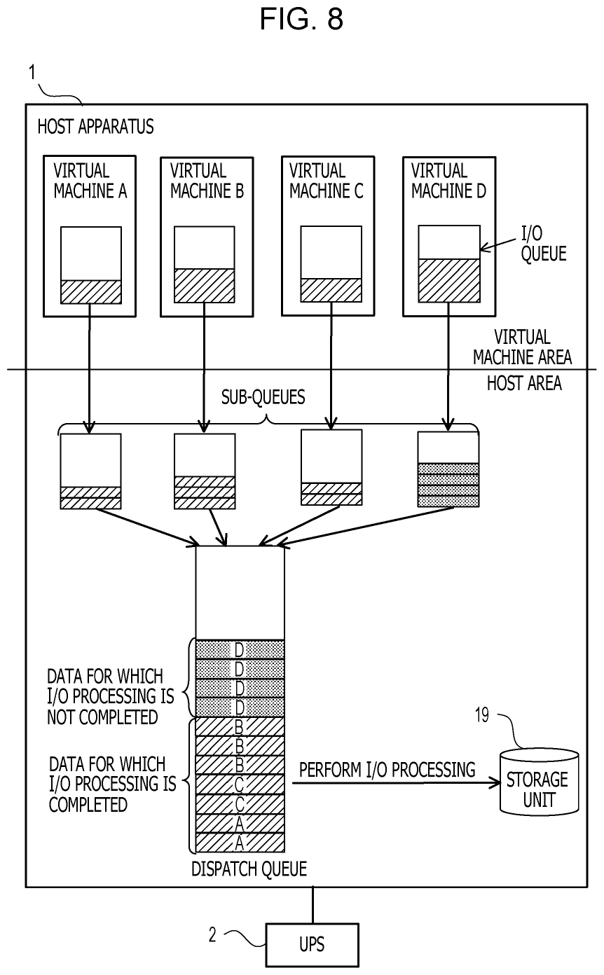

FIG. 8 is a diagram illustrating an example in which I/O processing is performed based on the priority when a power failure occurs in a virtual environment. The configuration of the system illustrated in FIG. 8 is substantially the same as that of the system illustrated in FIG. 2. When a power failure occurs while the host apparatus 1 is operating, the power supply of the host apparatus 1 is switched from the system power supply to the UPS 2.

For example, the precedence order setting unit 17 acquires, for each process, pieces of data held in the I/O queue by using the kernel space of the host area, and enqueues the pieces of data in the sub-queue prepared for the corresponding virtual machine. Then, the precedence order setting unit 17 sequentially moves the pieces of data to the dispatch queue from the piece of data held in the sub-queue for the virtual machine having the highest priority set by the priority setting unit 15. When the priority illustrated in FIG. 6 is used, the precedence order setting unit 17 accesses the sub-queues in an order of the virtual machines A, C, B, and D, and enqueues the pieces of data in the dispatch queue. The I/O execution unit 18 performs I/O processing to the storage unit 19 in an order in which the pieces of data are enqueued. That is, FIFO processing is applied to the sub-queues and the dispatch queue, for example.

In the example illustrated in FIG. 2, the I/O processing is not completed for the virtual machines B, C, and D within the predetermined virtual machine shutdown period. In contrast, in the example illustrated in FIG. 8, the virtual machine for which the I/O processing is not completed within the predetermined virtual machine shutdown period is only the virtual machine D.

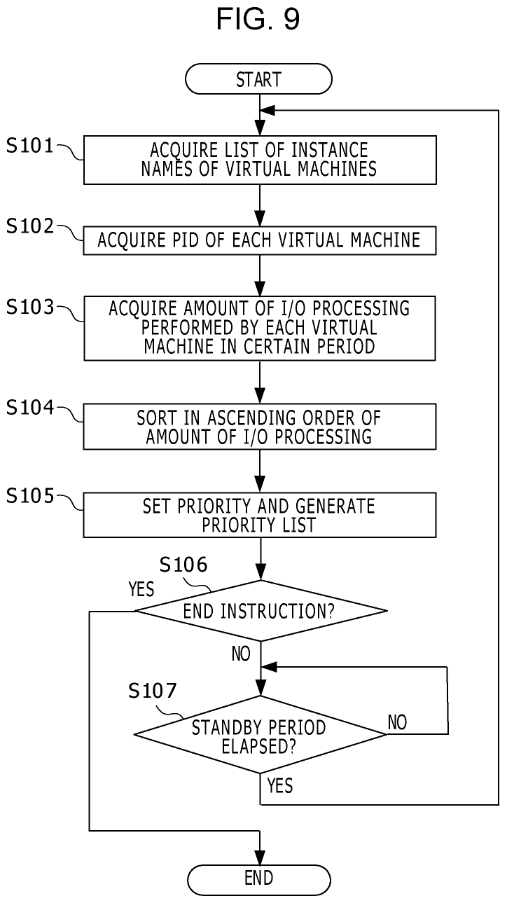

FIG. 9 is a flowchart illustrating an example of a process performed by the priority setting unit 15 according to the first embodiment. The priority setting unit 15 acquires a list of instance names of the respective virtual machines 12 from the management unit 14 (step S101). The priority setting unit 15 acquires the PIDs of the respective virtual machines 12 from the management unit 14 (step S102).

The priority setting unit 15 acquires, from the management unit 14, an amount of I/O processing from each of the virtual machines 12 to the storage unit 19 in a certain period (for example, one minute) (step S103). The priority setting unit 15 sorts the acquired sets of the PID and the amount of I/O processing of the virtual machines 12, in ascending order of the amount of I/O processing (step S104). The priority setting unit 15 sets a higher priority for the virtual machine 12 having a smaller amount of I/O processing, and generates the priority list (for example, FIG. 6) (step S105).

If the priority setting unit 15 receives an instruction to end the priority setting process from a user (YES in step S106), the process ends. If the priority setting unit 15 receives no instruction to end the priority setting process from a user (NO in step S106), the priority setting unit 15 determines whether a certain standby period has elapsed since the priority setting unit 15 generated the priority list last time (step S107). The certain standby period is, for example, ten seconds.

If the certain standby period has not elapsed since the priority setting unit 15 generated the priority list last time (NO in step S107), the priority setting unit 15 stands by until the certain standby period elapses. If the certain standby period has elapsed since the priority setting unit 15 generated the priority list last time (YES in step S107), the process returns to step S101. That is, the priority setting unit 15 updates the priority list at intervals of the certain standby period, for example.

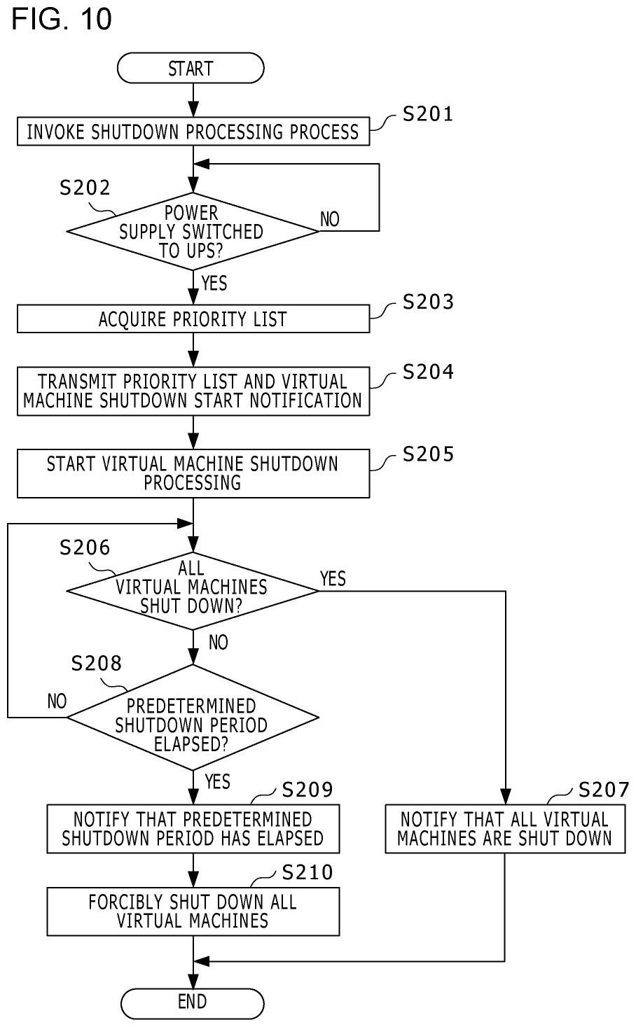

FIG. 10 is a flowchart illustrating an example of a process performed by the shutdown processing unit 16. The shutdown processing unit 16 invokes a shutdown processing process (step S201). The shutdown processing unit 16 determines whether the power supply of the host apparatus 1 is switched to the UPS 2 (step S202). For example, the UPS 2 transmits a certain notification to the host apparatus 1 when the UPS 2 starts supplying electric power to the host apparatus 1 from the battery included therein in response to a power failure. The shutdown processing unit 16 determines that the power supply is switched to the UPS 2 upon receipt of the notification.

If the power supply of the host apparatus 1 is not switched to the UPS 2 (NO in step S202), the shutdown processing unit 16 stands by until the power supply is switched. If the power supply is switched to the UPS 2 (YES in step S202), the shutdown processing unit 16 acquires the latest priority list from the priority setting unit 15 (step S203). The shutdown processing unit 16 transmits, to the precedence order setting unit 17, the priority list and a start notification indicating that the virtual machine shutdown processing is started (step S204).

As illustrated in FIG. 8, the priority setting unit 15 updates the priority list at intervals of the certain standby period. Therefore, the priority of the priority list acquired by the shutdown processing unit 16 in step S203 is a priority based on amounts of I/O processing performed by the respective virtual machines 12 immediately before the power supply of the host apparatus 1 is switched to the UPS 2.

The shutdown processing unit 16 starts virtual machine shutdown processing (step S205). For example, the shutdown processing unit 16 terminates applications, the OS, and the like that are running on each of the virtual machines 12. However, in the case where I/O processing to the storage unit 19 is unfinished for the virtual machine 12, the shutdown processing unit 16 does not complete the virtual machine shutdown processing until the I/O processing is completed.

If the virtual machine shutdown processing is completed for all the virtual machines 12 (YES in step S206), the shutdown processing unit 16 notifies the precedence order setting unit 17 that all the virtual machines 12 are shut down (step S207).

If the virtual machine shutdown processing is not completed for all the virtual machines 12 (NO in step S206) and the predetermined virtual machine shutdown period has elapsed (YES in step S208), the shutdown processing unit 16 notifies the precedence order setting unit 17 that the predetermined virtual machine shutdown period has elapsed (step S209). The shutdown processing unit 16 then forcibly shuts down all the virtual machines 12 (step S210).

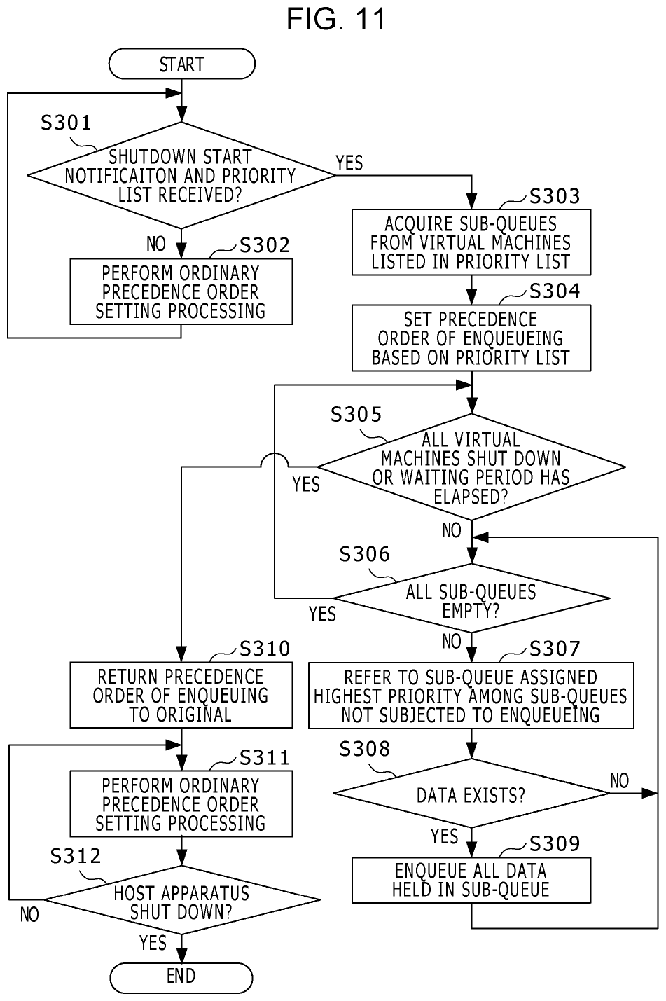

FIG. 11 is a flowchart illustrating an example of a process performed by the precedence order setting unit 17. If the precedence order setting unit 17 has not received the priority list and the shutdown processing start notification from the shutdown processing unit 16 (NO in step S301), the precedence order setting unit 17 performs ordinary precedence order setting processing until the precedence order setting unit 17 receives the priority list and the shutdown processing start notification (step S302).

If the precedence order setting unit 17 has received the priority list and the shutdown processing start notification from the shutdown processing unit 16 (YES in step S301), the precedence order setting unit 17 acquires, as the sub-queues, the I/O queues of the virtual machines listed in the priority list (step S303). If YES in step S301, the received priority list is a priority list based on amounts of I/O processing performed by the respective virtual machines 12 immediately before the power supply of the host apparatus 1 is switched to the UPS 2. Based on the priority list, the precedence order setting unit 17 sets the precedence order of enqueuing pieces of data from the sub-queues to the dispatch queue (step S304).

The precedence order setting unit 17 determines whether or not a notification indicating that all the virtual machines are shut down or a notification indicating that the predetermined virtual machine shutdown period (waiting period) has elapsed has been received from the shutdown processing unit 16 (step S305). If the precedence order setting unit 17 has received neither notification (NO in step S305), the precedence order setting unit 17 determines whether all the sub-queues acquired in step S303 are empty (step S306). If YES in step S306, the process returns to step S305.

If NO in step S306, the precedence order setting unit 17 refers to the sub-queue assigned the highest precedence order among the sub-queues for which data is not enqueued (step S307). The precedence order setting unit 17 determines whether data exists in the sub-queue that is referred to (step S308). If data exits in the sub-queue that is referred to (YES in step S308), the precedence order setting unit 17 enqueues all the data held in the sub-queue to the dispatch queue (step S309). If NO in step S308 or after the processing of step S309, the process returns to step S306. As described above, the precedence order setting unit 17 sets the precedence order of I/O processing from the virtual machines 12 to the storage unit 19 based on the priority list.

If YES in step S305, the precedence order setting unit 17 returns the order of enqueuing to the order set before the precedence order is set in step S304 (step S310). The precedence order setting unit 17 performs the ordinary precedence order setting processing on the pieces of data held in the sub-queues (step S311). If the host apparatus 1 is not shut down (NO in step S312), the precedence order setting unit 17 continues the processing of step S311 until the host apparatus 1 is shut down.

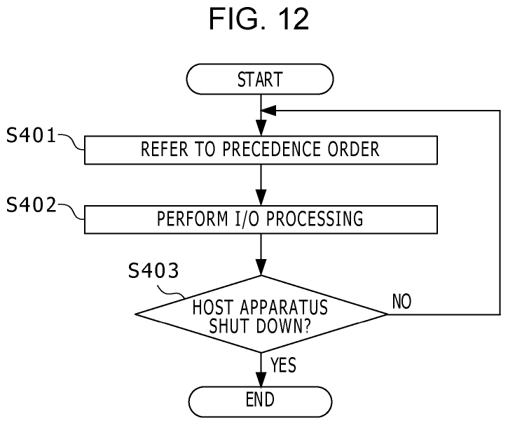

FIG. 12 is a flowchart illustrating an example of a process performed by the I/O execution unit 18. The I/O execution unit 18 acquires the latest precedence order set by the precedence order setting unit 17 (step S401). The I/O execution unit 18 refers to, as the precedence order, an order in which the pieces of data are enqueued in the dispatch queue, for example.

The I/O execution unit 18 performs, for each of the plurality of virtual machines 12, I/O processing from the virtual machine 12 to the storage unit 19 based on the precedence order which the I/O execution unit 18 refers to (step S402). If the host apparatus 1 is not shut down (NO in step S403), the I/O execution unit 18 repeatedly performs the processing of steps S401 and S402 until the host apparatus 1 is shut down.

Note that the processes illustrated in FIGS. 9 to 12 are performed in parallel with one another.

### Second Embodiment

A second embodiment will be described below. In the second embodiment, the CPU usage is used as the processing load of each of the plurality of virtual machines 12 for use in setting the priority. The CPU is an example of a processor. Note that the system configuration according to the second embodiment is substantially the same as the system configuration according to the first embodiment illustrated in FIG. 4.

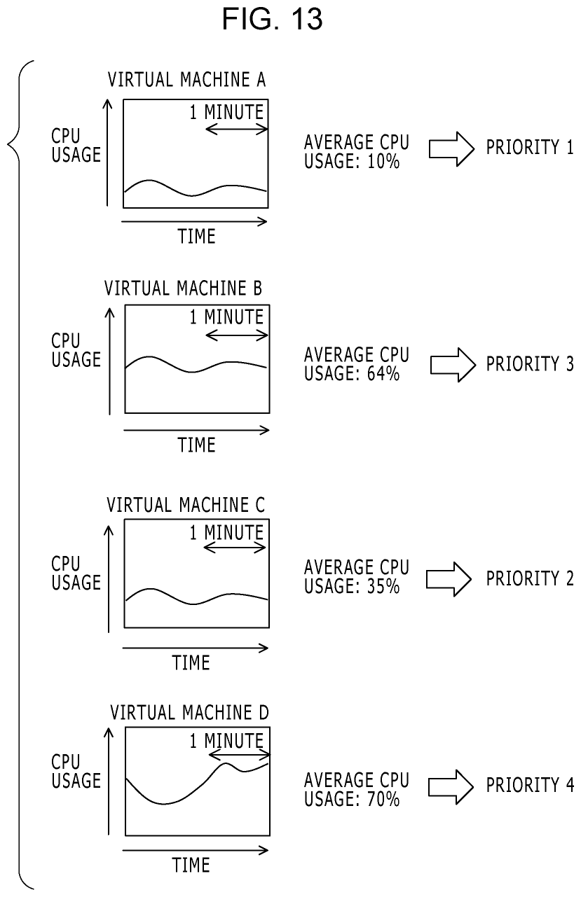

FIG. 13 is a diagram illustrating a second example of the priority setting method. In the example illustrated in FIG. 13, the priority setting unit 15 sets the priority based on the average CPU usages of the respective virtual machines in a certain period (one minute) immediately before the power supply is switched to the UPS 2. Note that the period used for setting is not necessarily one minute.

In the example illustrated in FIG. 13, the average CPU usages of the virtual machines A, B, C, and D in the certain period (one minute) immediately before the power supply is switched to the UPS 2 is 10%, 64%, 35%, and 70%, respectively. The priority setting unit 15 sets a higher priority for the virtual machine 12 having a lower CPU usage in the certain period immediately before the power supply of the host apparatus 1 is switched to the UPS 2.

When the CPU usage in the period immediately before the power supply is switched to the UPS 2 is high, it is considered that an amount of I/O processing remaining at the time of a power failure is also large. Therefore, the priority setting unit 15 sets a higher priority for the virtual machine 12 having a lower CPU usage. Consequently, the shutdown process of the virtual machine 12 is completed earlier, and the possibility that I/O processing is not completed for the other virtual machines is successfully reduced. Accordingly, the host apparatus 1 may increase the number of virtual machines that is successfully shut down safely.

The host apparatus 1 sets an amount of I/O processing by using the CPU usage in a period immediately before the power supply is switched to the UPS 2. Thus, the host apparatus 1 may appropriately set the priority even in a system in which the CPU usage varies depending on timing.

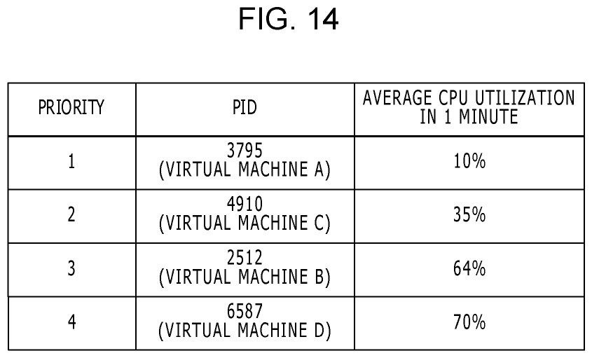

FIG. 14 is a diagram illustrating a second example of the priority list. The priority list illustrated in FIG. 14 is generated in the case where the priority is set in accordance with the method illustrated in FIG. 13. In the priority list illustrated in FIG. 14, the priority, the PID of the virtual machine, and the CPU usage in a one-minute period immediately before the power supply is switched to the UPS 2 are stored in association with one another. In the example illustrated in FIG. 14, a higher priority is set in ascending order of CPU usage. For example, a higher priority is set in an order of the virtual machines A, C, B, and D.

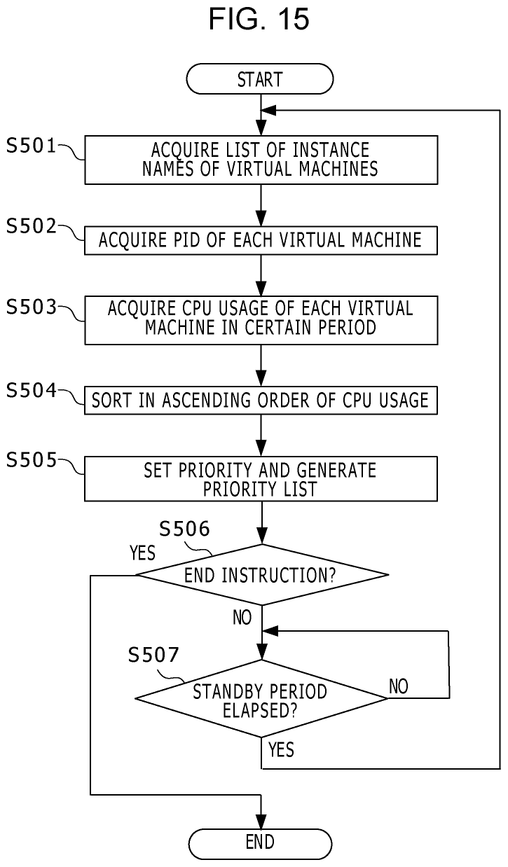

FIG. 15 is a flowchart illustrating an example of a process performed by the priority setting unit 15 according to the second embodiment. The priority setting unit 15 acquires a list of instance names of the respective virtual machines 12 from the management unit 14 (step S501). The priority setting unit 15 acquires the PIDs of the respective virtual machines 12 from the management unit 14 (step S502).

The priority setting unit 15 acquires the average CPU usages of the respective virtual machines 12 in a certain period (for example, one minute) from the management unit 14 (step S503). The priority setting unit 15 sorts the acquired sets of the PID and the average CPU usage of the virtual machines 12 in ascending order of the average CPU usage (step S504). The priority setting unit 15 sets a higher priority for the virtual machine 12 having a lower CPU usage in the certain period, and generates the priority list (for example, FIG. 14) (step S505).

If the priority setting unit 15 receives an instruction to end the priority setting process from a user (YES in step S506), the process ends. If the priority setting unit 15 receives no instruction to end the priority setting process from a user (NO in step S506), the priority setting unit 15 determines whether a certain standby period has elapsed since the priority setting unit 15 generated the priority list last time (step S507). The certain standby period is, for example, ten seconds.

If the certain standby period has not elapsed since the priority setting unit 15 generated the priority list last time (NO in step S507), the priority setting unit 15 stands by until the certain standby period elapses. If the certain standby period has elapsed since the priority setting unit 15 generated the priority list last time (YES in step S507), the process returns to step S501. That is, the priority setting unit 15 updates the priority list at intervals of the certain standby period, for example.

The priority setting unit 15 may set the priority by using, instead of the average CPU usages of the respective virtual machines in a certain period, the maximum or minimum CPU usages or the like of the respective virtual machines in the certain period.

The processes performed by the shutdown processing unit 16, the precedence order setting unit 17, and the I/O execution unit 18 according to the second embodiment are substantially the same as those of the first embodiment illustrated in FIGS. 10 to 12.

<Hardware Configuration>

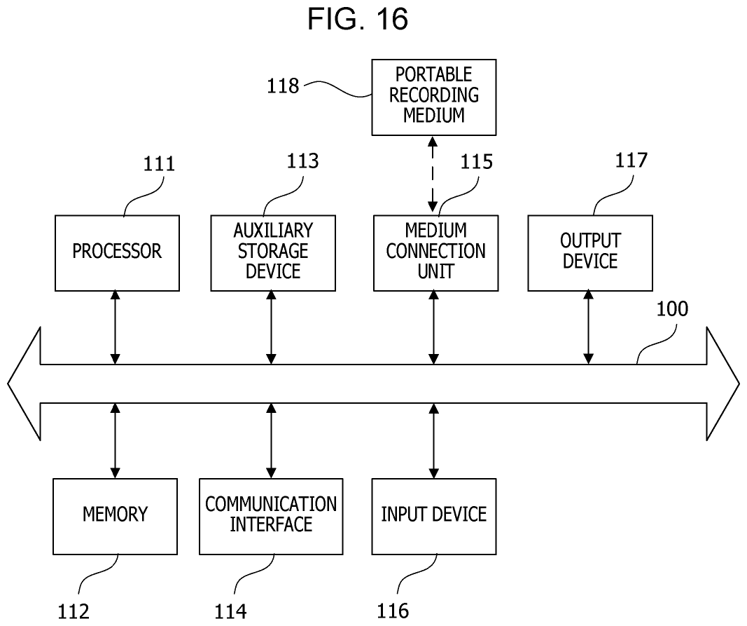

An example of a hardware configuration of the host apparatus 1 will be described next. FIG. 16 is a diagram illustrating an example of the hardware configuration of the host apparatus 1. As illustrated in the example of FIG. 16, a processor 111, a memory 112, an auxiliary storage device 113, a communication interface 114, a medium connection unit 115, an input device 116, and an output device 117 are connected to a bus 100 in the host apparatus 1.

The processor 111 executes a program loaded to the memory 112. A setting program causing the processes according to each of the embodiments to be performed may be used as the program to be executed.

The memory 112 is, for example, a random access memory (RAM). The auxiliary storage device 113 is a storage device that stores various kinds of information. For example, a hard disk drive, a semiconductor memory, or the like may be used as the auxiliary storage device 113. The setting program causing the processes according to each of the embodiments to be performed may be stored in the auxiliary storage device 113. The storage unit 19 illustrated in FIGS. 4 and 8 may be implemented by the auxiliary storage device 113. The I/O queues, the sub-queues, and the dispatch queue illustrated in FIG. 8 may be implemented by the memory 112.

The communication interface 114 is connected to a communication network such as a local area network (LAN) or a wide area network (WAN). The communication interface 114 performs data conversion or the like involved in communication.

The medium connection unit 115 is an interface to which a portable recording medium 118 is connectable. An optical disc (for example, a compact disc (CD) or a digital versatile disc (DVD)), a semiconductor memory, or the like may be used as the portable recording medium 118. The setting program causing the processes according to each of the embodiments to be performed may be stored on the portable recording medium 118.

The input device 116 is, for example, a keyboard, a pointing device, or the like. The input device 116 accepts input of an instruction, information, and so forth from a user.

The output device 117 is, for example, a display device, a printer, a speaker, or the like. The output device 117 outputs an inquiry and an instruction to a user, a processing result, and so forth.

The virtualization software 11, the management unit 14, the priority setting unit 15, the shutdown processing unit 16, the precedence order setting unit 17, and the I/O execution unit 18 illustrated in FIG. 4 may be implemented by the processor 111 executing the setting program loaded to the memory 112.

The memory 112, the auxiliary storage device 113, and the portable recording medium 118 are non-transitory computer-readable physical storage media and are not temporary media such as signal carriers.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and configured to:
set a priority for each of a plurality of virtual machines such that a higher priority is given for a virtual machine having a lower processing load,
set a precedence order of Input/Output (I/O) processing based on the priority in a case where a power supply of the information processing apparatus is switched to an uninterruptible power supply, the priority being based on processing loads of the plurality of virtual machines immediately before the power supply of the information processing apparatus is switched to the uninterruptible power supply, the I/O processing indicating at least one of writing from each of the plurality of virtual machines to the memory and reading from the memory to the virtual machine, and
perform, for each of the plurality of virtual machines, the I/O processing from the virtual machine to the memory in accordance with the precedence order.

2. The information processing apparatus of claim 1, wherein
the processor acquires information concerning the processing loads of the plurality of virtual machines from software that manages the plurality of virtual machines.

3. The information processing apparatus of claim 1, wherein
the processor sets the priority for each of the plurality of virtual machines such that a higher priority is given for a virtual machine that has performed a smaller amount of I/O processing in a certain period immediately before the power supply of the information processing apparatus is switched to the uninterruptible power supply.

4. The information processing apparatus of claim 1, wherein
the processor sets the priority for each of the plurality of virtual machines such that a higher priority is given for a virtual machine whose processor usage is lower in a certain period immediately before the power supply of the information processing apparatus is switched to the uninterruptible power supply.

5. A non-transitory, computer-readable recording medium having stored therein a program for causing a computer to execute a process, the process comprising:
setting a priority for each of a plurality of virtual machines such that a higher priority is given for a virtual machine having a lower processing load;
setting a precedence order of Input/Output (I/O) processing based on the priority in a case where a power supply of an information processing apparatus is switched to an uninterruptible power supply, the priority being based on processing loads of the plurality of virtual machines immediately before the power supply of the information processing apparatus is switched to the uninterruptible power supply, the I/O processing indicating at least one of writing from each of the plurality of virtual machines to the memory and reading from the memory to the virtual machine; and
performing, for each of the plurality of virtual machines, the I/O processing from the virtual machine to the memory in accordance with the precedence order.

6. The non-transitory, computer-readable recording medium of claim 5, the process further comprising acquiring information concerning the processing loads of the plurality of virtual machines from software that manages the plurality of virtual machines.

7. The non-transitory, computer-readable recording medium of claim 5, the process further comprising setting the priority for each of the plurality of virtual machines such that a higher priority is given for a virtual machine that has performed a smaller amount of I/O processing in a certain period immediately before the power supply of the information processing apparatus is switched to the uninterruptible power supply.

8. The non-transitory, computer-readable recording medium of claim 5, the process further comprising setting the priority for each of the plurality of virtual machines such that a higher priority is given for a virtual machine whose processor usage is lower in a certain period immediately before the power supply of the information processing apparatus is switched to the uninterruptible power supply.
